(19) United States
(12) Patent Application Publication
(10) Pub. No.: US 2006/0226235 A1
(43) Pub. Date: Oct. 12, 2006

(54) Durable photo card

(76) Inventors: John D. Shepherd, Newport Beach, CA (US); Deborah S. Shepherd, Newport Beach, CA (US); Roni D. Jackson, Newport Beach, CA (US); William M. Pierce, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/245,368

(22) Filed: Oct. 6, 2005

Related U.S. Application Data
(60) Provisional application No. 60/669,794, filed on Apr. 8, 2005.

(51) Int. Cl. G06K 19/00

(52) U.S. Cl. 235/487

(57) ABSTRACT

A photo card comprises a photographic image printed on a substantially durable card, such as a plastic card. An image is printed on at least a first side of the card, the image extending across a surface of the card, wherein substantially the entire area of the card is occupied by the image. In another example, the photo card includes multiple images on one or both sides of the card.

### RELATED APPLICATION

This application claims the benefit of priority under 35 U.S.C. § 119(e) of U.S. Provisional Patent Application No. 60/669,794, filed on Apr. 8, 2005, entitled “Durable Photo Card” the entirety of which is incorporated herein by reference.

### BACKGROUND

1. Field of the Invention

The invention relates in general to photographic images printed on substantially durable cards.

2. Description of the Related Art

Many people carry wallet-sized photographs of loved ones, family members, pets and other subjects in their wallets or purses. Unfortunately, there is really no good place to put a wallet-sized photograph in a wallet or purse. With few choices, people often place their wallet-sized photograph amid the dollar bills in their wallet, slide it between credit cards, or place it loosely in a pocket in their purse. Traditionally, wallet-sized photographs are printed by photographic, mechanical, and other processes on standard photographic paper. Such standard photographic paper is lightweight, bends easily, scratches easily, degrades and discolors over time, and is generally not particularly durable. As a result, photographs in a wallet are often quickly damaged (e.g., crumpled, creased, scratched, torn, etc.) through the frequent use and folding of a wallet, scratching as a result of the other elements in a wallet or purse, and generally from the normal wear and tear caused from the daily use of a wallet or purse.

In another, heretofore unrelated field, identification badges have long been used as security devices. These badges contain information on them for use in identifying the person with the badge. These badges are used to limit access to buildings, rooms within buildings, and to certain events. The badges have a significant security role in that they are used to prevent members of the general public or specific persons from accessing certain buildings, areas, or events, to protect confidential or proprietary information, or to ensure that only those authorized to be at an event are able to gain access. Such ID badges also often contain a hologram, magnetic strip, microchip or other electronic or mechanical security measure. These security measures either provide further identifying information or interact with other security equipment. A badge that does not properly identify a person or function properly could lead to a breach in security with possibly significant losses or consequences.

### SUMMARY

Embodiments of the present invention provide substantially durable photograph prints by providing a durable plastic card with the image printed thereon. In some embodiments, an image is printed on one side of a plastic ID-card blank such that the image extends across substantially the entire surface of the card. In alternative embodiments, both sides of the card can be printed with images. In further alternative embodiments, a plurality of images can be printed on a single surface of a card in a side-by-side or other arrangement.

### BRIEF DESCRIPTION OF THE DRAWINGS

Having thus summarized the general nature of the invention, certain preferred embodiments and modifications thereof will become apparent to those skilled in the art from the detailed description herein having reference to the figures that follow, of which:

FIG. 1 is a schematic perspective view of one embodiment of a photo card.

FIG. 2 is a front view of an embodiment of a photo card.

FIG. 3 is a front view of another photo card.

### DETAILED DESCRIPTION OF THE PREFERRED EMBODIMENTS

Embodiments of a durable photo card will now be described with reference to the attached figures. The durable photo card generally comprises a plastic card with an image, typically a photographic image printed on at least one side thereof. In one preferred embodiment, the photograph extends across substantially the entire surface of the card.

The card 10 is typically made of a durable plastic, such as PVC. In one embodiment, the card is a standard blank PVC ID card. ID card blanks can be obtained from many retail and wholesale sources in a variety of shapes, sizes, thicknesses and colors. The photo card can be any desired base color, although white cards are typically preferred in order to provide a neutral background.

The card 10 preferably does not include any raised lettering or numbering, nor any security or machine-readable devices such as smart cards, RFID chips, magnetic elements, etc.

In other embodiments, the card 10 may comprise credit cards, microchip-containing smart cards, cards containing magnetic data storage devices, automatic teller machine (ATM) access cards, radio frequency (“RF”) and non-radio frequency access/security cards, telephone access and stored value cards, stored value gift cards containing monetary value which can be redeemed at business establishments, customer and member “loyalty” cards such as distributed by retail businesses, travel-related businesses (airlines, hotels, auto rental, etc.), clubs, sports and entertainment establishments, and similar card-like devices. Furthermore, in other embodiments the card 10 may have a flat shape or a coin-like shape or other shapes dimensioned to have a photographic image printed thereon.

The photo card 10 can also be any thickness as desired. In some embodiment, the photo card 10 corresponds in length, width, and height approximately to the size of a financial transaction card. For example, the photo card 10 may have a a length of about 86 mm, width of about 54 mm and thickness of about 0.76 mm.

Photo cards can also be provided in a number of sizes. For example, in one embodiment, a photographic image is printed on a card with a width of about 2.125 inches and a length of about 3.625 inches.

In other embodiments the width or length of the photo card 10 is less than the width or length of a financial transaction card. In still other embodiments, the width or length of the photo card 10 is greater than the width or length of a financial transaction card. Alternatively, shapes with other dimensions can also be used.

In other embodiments, the thickness of the photo card 10 is greater than the thickness of a financial transaction card. For example, the thickness of the photo card 10 can be 1.5 times, 2 times, 2.5 times, 3 times, or greater than 3 times the thickness of a financial transaction card. In yet other embodiments, the thickness of the photo card 10 is less than the thickness of a financial transaction card. For example, the thickness of the photo card 10 may be about 5 mm or less, and in certain embodiments about less than 1 mm.

The material from which the photo card 10 is made can be either plastic, such as PVC or ABS; rubber, such as a silicone compound; metal, such as a stainless steel or a brass, or a tempered stainless steel or brass; wood; any composite of one or more of these materials; or any other suitable material in order to achieve suitable properties such as durability, semi-rigidness or rigidness, surface texture and color. Certain embodiments can utilize highly elastic metal materials, such as nickel titanium, as components for the body. Certain embodiments can utilize materials for the body which are recyclable, such as ABS plastics and rubbers. Certain other embodiments can utilize materials for the body which are biodegradable, such as common starches, such as corn, wheat and potato starch, or such as natural resins and gums.

As used herein, the term “photograph” is used in its ordinary sense, and generally refers to an image obtained through a photographic film process, a digital image capture process, or any other suitable image-capturing process. In the context of the durable photo card described herein, the photograph is the main focal point of the card. While many prior art cards have been printed with photographic images of various sizes, the images on such cards typically identify either a user or an issuer of the card. The subject of a photographic image on a card as described herein will often be similar to the subject matter of a photograph typically carried in a person's wallet, such as portraits of family members, pets, significant others, etc.

Many printers are available that are capable of printing on cards by a number of processes. Any available printer or process can be used to make a photo card as described herein. For example, either direct-to-print or reverse transfer printing processes can be used. Reverse transfer printing processes advantageously allow an image to be printed more closely to the card's edge, and also provide a protective layer between the image and the exposed surface of the card, thereby preventing scratching of the image. Additionally, many software programs are available which can be used to print images in desired patterns on cards. Any suitable software program can be used to print a photo card as described herein.

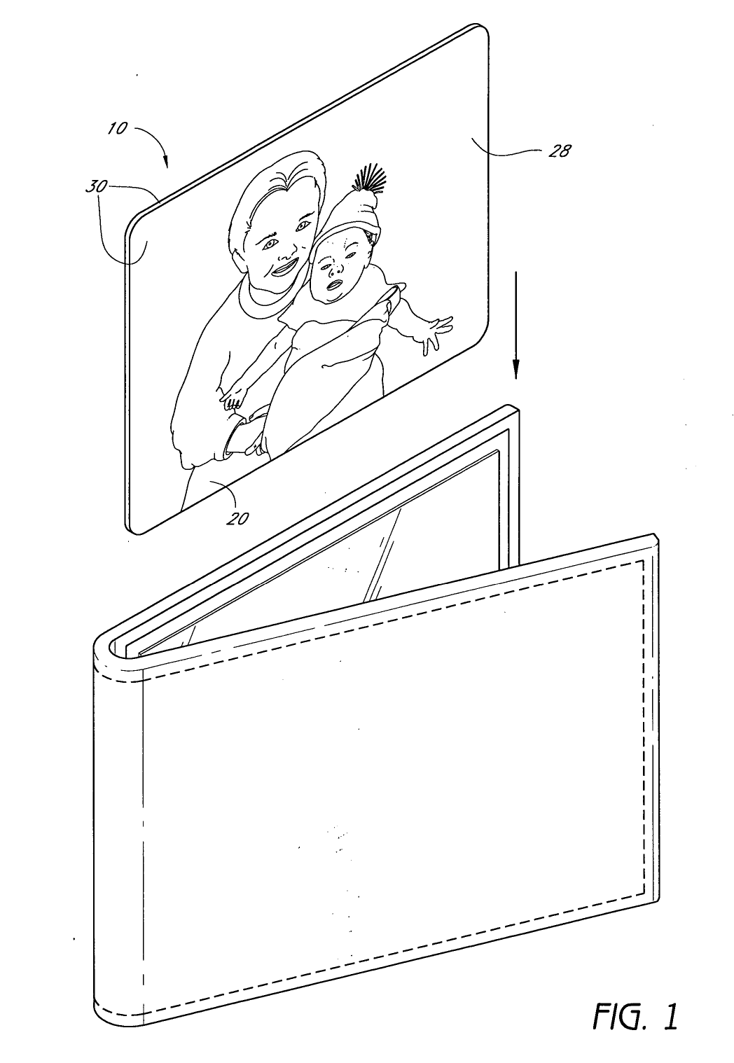

In one embodiment, shown for example in FIG. 1, a photo card 10 is printed with a single image 20 occupying an entire surface 28 of the card 10. The single image 20 extends as closely as possible to the edges 30 of the card 10. In some embodiments, the elimination of any space between the edge 30 of the card 10 and the edge 36 of the image 20 will only be limited by the abilities of a given printer. For example, in some cases, printers using a reverse transfer printing process can print an image with substantially no space between the edge of the image and the edge of the card. In other examples, some direct printers can only print an image to within one 50^{th} of an inch of the card's edge.

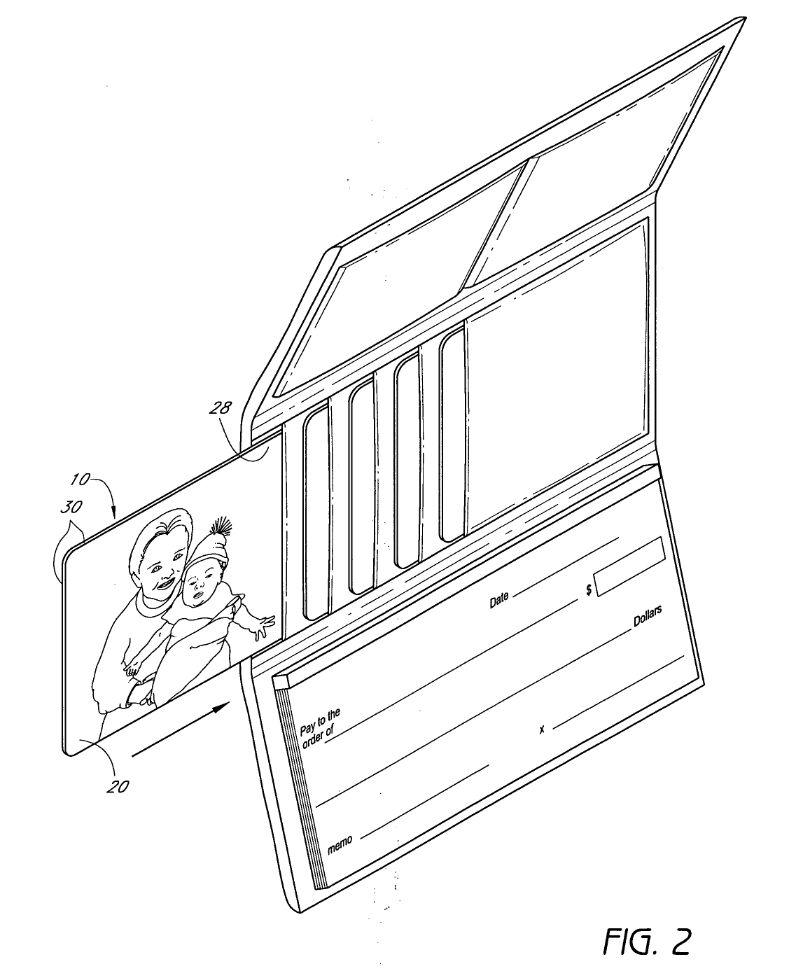

In an alternative embodiment, as illustrated in FIG. 2, an image on a photo card 10 can be surrounded by a border 40 or “frame.” The particular size, pattern, color and design of the frame 40 can vary substantially as desired by the user. In a preferred embodiment, the outer perimeter 46 of the frame 40 is printed as closely as possible to the card's edge 30. In some embodiments, there is substantially no gap between the inner perimeter 50 of the border 40 and the outer perimeter of the image 20.

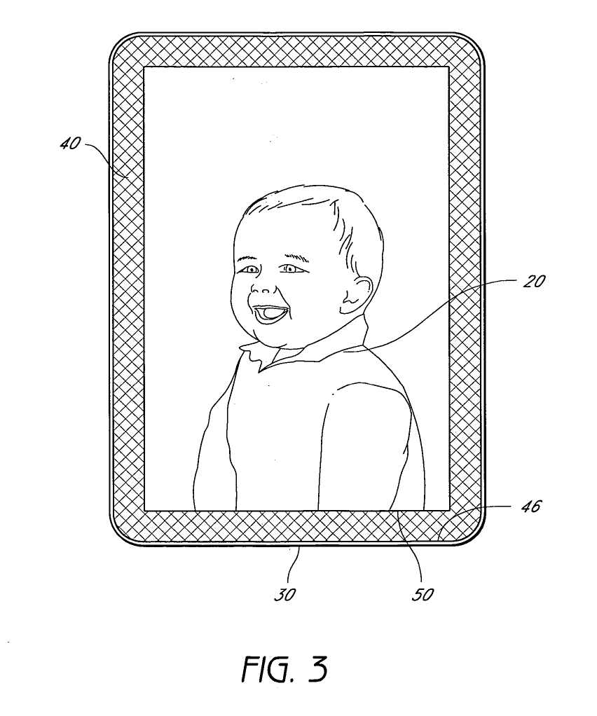

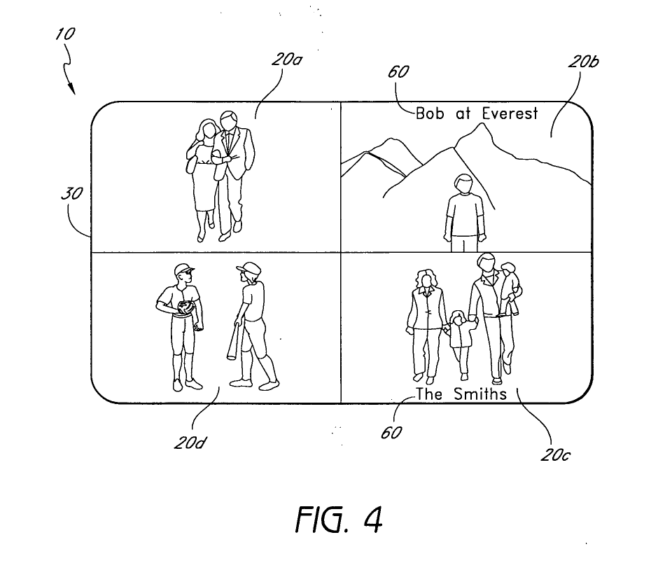

In another embodiment, as shown for example in FIG. 3, a plurality of smaller images 20a-d can be printed on a photo card 10 in a tiled or other orientation. The embodiment shown in FIG. 3 comprises four images oriented in a “tiled” pattern. In alternative embodiments, two, three, five or more images can be printed in any desired pattern on a single side of a card.

In some embodiments, as illustrated in FIG. 3, a legend 60 can be printed on or adjacent to each image 20b, 20c in order to provide information about the subject of the image 20b, 20c. Similarly, such legends 50 can also be provided on images that extend across substantially an entire card surface, such as those illustrated in FIGS. 1 and 2.

In some embodiments, it may be desirable to print a single image on one side of the photo card 10. In other embodiments, multiple images may be printed side-by-side on a surface of the photo card 10. For example two photos could be printed side-by-side in a split screen fashion on one side of the photo card 10. In yet other embodiments, various patterns of images could be printed on a surface of the photo card 10.

In some embodiments, it may be desirable to print images on both sides of the card 10. In such cases, images can be printed on both sides of the card 10 in any of the above manners. For example, a first side of a card 10 may be printed with a single image extending across substantially the entire first surface (e.g. as shown in FIG. 1 or 2), while the second side of the card 10 can be printed with a plurality of images (e.g. as shown in FIG. 3). Alternatively, both sides of the card 10 can be printed with images in substantially the same pattern. Typically, the first image on the first side of the card 10 is a different image from the second image on the second side of the card. Often, the first image will be a photograph of a different subject matter than the second image.

In other embodiments, it may be desirable to attach a fastener such as one or more magnets to the back of the card 10. The card 10 could then magnetically attach to different surfaces such as, by way of example, the door of a refrigerator. Alternatively, the images could be printed onto a magnetic card 10. Such a magnetic card 10 may be printed with a single image extending across substantially the entire first surface while the second side of the card 10 can be printed with a plurality of images. In yet another embodiment, both sides of the magnetic card 10 can be magnetized so that a different image can be displayed by flipping the card and reaffixing it to a magnetically attractive surface. In additional embodiments, the back of the card 10 can have an applied adhesive. The card 10 could then be adhered to a wide variety of different surfaces. In yet other embodiments, the fastener on the back of the card 10 could be configured to attach to a variety of surfaces such as by way of example fabrics, clothing, walls, and the like. Such a fastener could by way of example include a pin, Velcro or a tab.

Although certain embodiments and examples have been described herein, it will be understood by those skilled in the art that many aspects of the methods and devices shown and described in the present disclosure may be differently combined and/or modified to form still further embodiments. Additionally, it will be recognized that the methods described herein may be practiced using any device suitable for performing the recited steps. Such alternative embodiments and/or uses of the methods and devices described above and obvious modifications and equivalents thereof are intended to be within the scope of the present disclosure. Thus, it is intended that the scope of the present invention should not be limited by the particular embodiments described above, but should be determined only by a fair reading of the claims that follow.

What is claimed is:

1. A device comprising:
a plastic card; and
an image printed on at least a first side of the card, the image extending across a surface of the card, wherein substantially the entire area of the card is occupied by the image.

2. The device of claim 1, wherein the card does not include any member of the group consisting of: a magnetic strip, an RFID tag, a microchip, a hologram, raised alphanumeric characters and a bar code.

3. The device of claim 1, wherein the image is printed to within one tenth of an inch of an edge of the card.

4. The device of claim 1, further comprising a second image printed on a second side of the card, wherein the second image occupies substantially the entire area of the second surface.

5. The device of claim 1, further comprising a border surrounding the image.

6. The device of claim 1, wherein the image is a photographic image.

7. The device of claim 1, wherein at least one side of the card has a magnet thereon.

8. The device of claim 1, wherein at least one side of the card is coated with an adhesive.

9. The device of claim 1, wherein a fastener is mounted to at least one side of the card.

10. The device of claim 9, wherein the fastener is configured to attach the card to clothing.

11. A device comprising:
a plastic card; and
at least first and second images printed on a first side of the card, the images extending across the surface of the card, wherein substantially the entire area of the card is occupied by said at least first and second images.

12. The device of claim 11, wherein the card does not include any member of the group consisting of: a magnetic strip, an RFID tag, a microchip, a hologram, raised alphanumeric characters and a bar code.

13. The device of claim 12, wherein the first and second images are printed to within one tenth of an inch of an edge of the card.

14. The device of claim 11, further comprising a plurality of images printed on a second side of the card, wherein the plurality of images collectively occupy substantially the entire area of the second surface.

15. The device of claim 11, further comprising a second image printed on a second side of the card, wherein the second image occupies substantially the entire area of the second surface.

16. The device of claim 11, further comprising a border surrounding the image.

17. The device of claim 11, wherein at least one of the first and second images is a photographic image.

18. The device of claim 11, wherein at least one side of the card has a magnet thereon.

19. The device of claim 11, wherein at least one side of the card is coated with an adhesive.

20. The device of claim 11, wherein a fastener is mounted at least one side of the card.

21. The device of claim 20, wherein the fastener is configured to attach the card to clothing.
